(19) United States
(12) Patent Application Publication
(10) Pub. No.: US 2014/0199665 A1
(43) Pub. Date: Jul. 17, 2014

(54) FOOD SELECTION SYSTEM AND METHOD OF USING THE SAME

(71) Applicant: Sima Tessema, Washington, DC (US)

(72) Inventor: Sima Tessema, Washington, DC (US)

(21) Appl. No.: 13/739,288

(22) Filed: Jan. 11, 2013

(51) Int. Cl. G09B 25/00

(52) U.S. Cl. CPC G09B 25/00
USPC 434/127

(57) ABSTRACT

A food selection system which includes a housing have at least one storage compartment and a plurality of air vents and an aroma creation device to create an aroma stored within at least one storage compartment, wherein an exterior surface of the housing resembles a food item, and the plurality of air vents connect the at least one storage compartment to the exterior surface.

### BACKGROUND OF THE INVENTION

1. Field of the Invention

The present general inventive concept relates to a food selection system and method of using the system to promote sales of prepared food items. More particularly, to a food selection system which replicates the image, the portion size, and the smell of a particular food item.

2. Background

Many businesses use models to give customers a more precise image of a particular product. For instance, restaurants may use colored pictures and plastic models which replicate their dishes to allow customers to make a more informed decision, based on appearance and relative portion size. However, conventional methods and devices do not cater to all of the senses a customer uses in making decisions regarding food selection.

Therefore, a method and/or device which appeal to all of a customer's senses in making a decision regarding food are highly desirable.

### BRIEF SUMMARY OF THE INVENTION

The present general inventive concept provides a food selection system which includes a housing having at least one storage compartment, a plurality of air vents, and an aroma creation device to create an aroma stored within at least one storage compartment, wherein an exterior surface of the housing resembles a food item, and the plurality of air vents connects at least one storage compartment to the exterior surface. The aroma created by the aroma creation device may be emitted through an exterior surface through the plurality of air vents.

The food selection system may further include a second storage compartment disposed within the housing, the second storage compartment configured to store a smoke or steam creation device, wherein the second storage compartment is in fluid communication with the plurality of air vents.

The smoke creation device may include a dry ice smoke machine.

The present general inventive concept also provides a method for using a food selection system, the food selection system including a housing having a plurality of storage compartments and a plurality of air vents, the method includes creating the housing to resemble a desired food item, installing an aroma creation device to create an aroma corresponding to the food item disposed within a first storage compartment of the plurality of storage compartments, displaying the housing and activating the aroma creation device, wherein the aroma corresponds to the food item.

The housing may further include a second storage compartment configured to store dry ice, the method further includes dropping a liquid into the plurality of air vents to contact the stored dry ice to release vapor or steam through the plurality of air vents.

In an exemplary embodiment, the food selection system would be utilized in the restaurant industry or various other places where prepared foods are sold in order to convey to customers what a particular food item on the menu actually looks like and actually smells like to promote the selection and purchase of a desired food item.

Additional aspects and utilities of the present general inventive concept will be set forth in part in the description which follows and, in part, will be obvious from the description, or may be learned by practice of the general inventive concept.

### BRIEF DESCRIPTION OF THE DRAWINGS

These and/or other utilities and advantages of the present general inventive concept will become apparent and more readily appreciated from the following description of the embodiments, taken in conjunction with the accompanying drawings of which:

FIG. 1 is a front perspective of a food selection system according to an exemplary embodiment of the present general inventive concept;

FIG. 2 is a front perspective schematic view of the food selection system illustrated in FIG. 1;

FIG. 3 is a top plan view of the food item replica according to another exemplary embodiment;

FIG. 4 is a top perspective schematic view of the food item replica according to another exemplary embodiment;

FIG. 5 is top plan view of the food item replica illustrated in FIG. 4; and

FIG. 6 is a cross-sectional schematic view of the food item replica according to another exemplary embodiment.

### DETAILED DESCRIPTION OF THE PREFERRED EMBODIMENTS

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

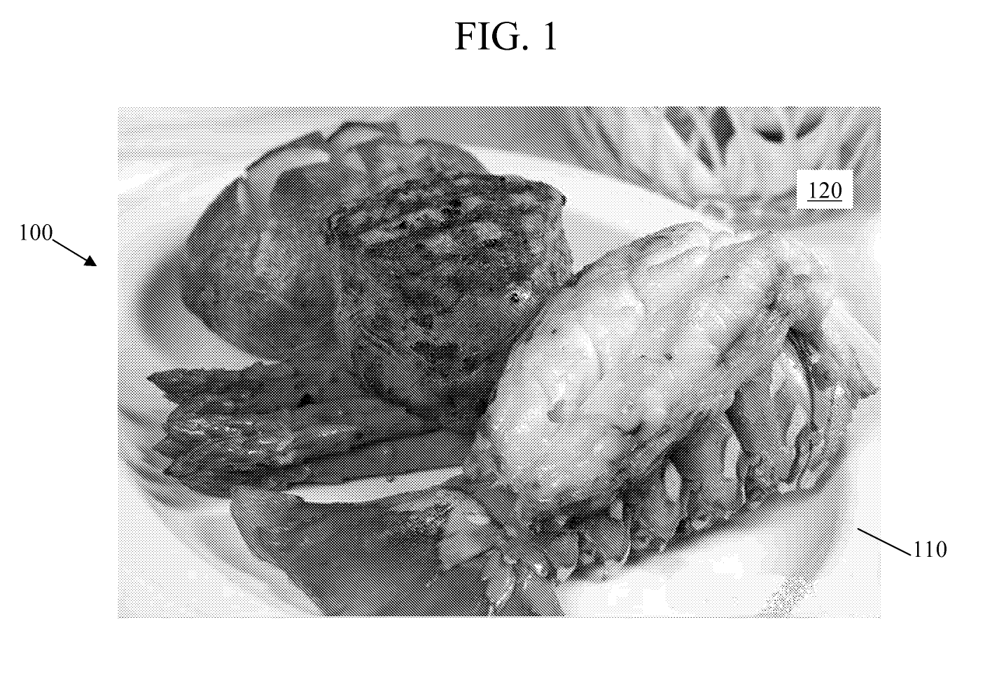

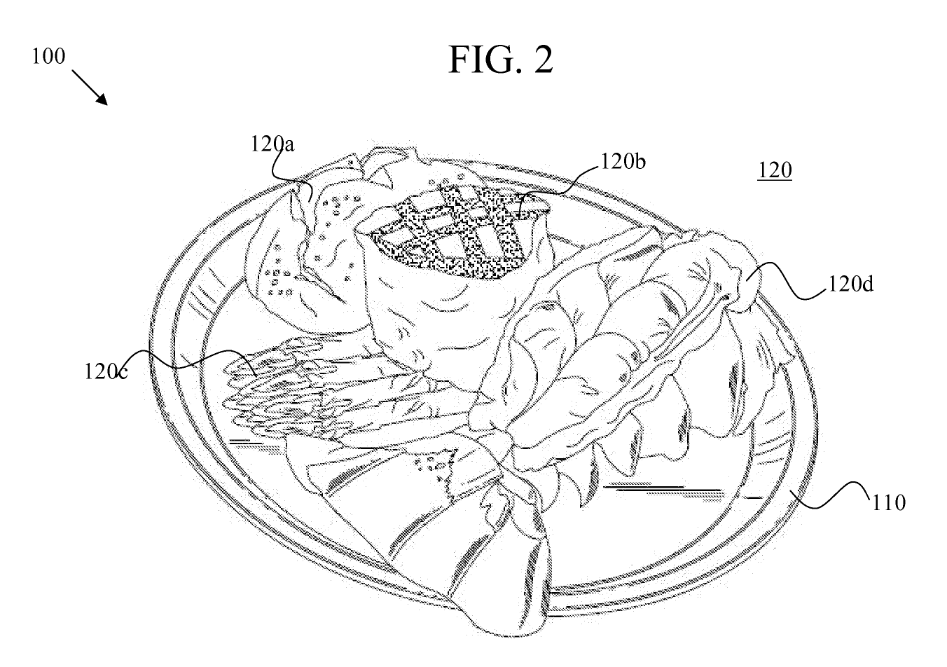

FIG. 1 is a front perspective of a food selection system 100 according to an exemplary embodiment of the present general inventive concept and FIG. 2 is a front perspective schematic view of the food selection system 100 illustrated in FIG. 1.

An exemplary embodiment of the food selection system 100 includes a serving platform 110 and a food item replica 120. The food item replica 120 is identical to a food item on a menu at a particular restaurant, for instance. That is, the food item replica 120 resembles the look, feel, and portion size of a desired food item. The restaurant may use the food item replica 120 to convey what food items actually look like to a potential customer. The customer would then be aware of what the food item looks like as well as the relative portion size, when making a purchase decision.

Referring to FIG. 2, in the present exemplary embodiment, the food item replica 120 includes a first portion resembling a baked potato 120a; a second portion resembling a steak 120b; a third portion resembling asparagus 120c; and a forth portion resembling a lobster 120d. However, the present general inventive concept is not limited thereto. That is, in exemplary embodiments, the food item replica 120 may include a plurality of portions or plurality of dishes that resemble a particular dish prepared at a restaurant. For instance, in an alternative exemplary embodiment, the food item replica 120 may include a portion that resembles a chocolate cake that is identical to the size, shape, and color of the chocolate cake sold at a particular restaurant.

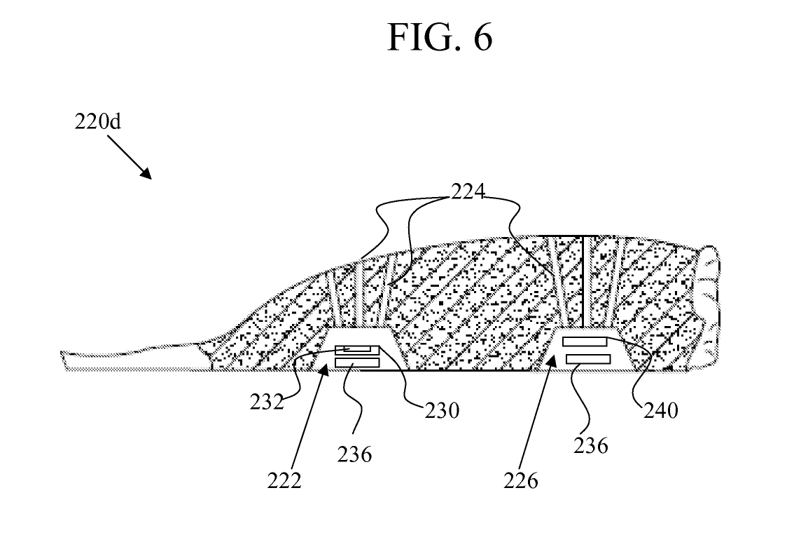

In exemplary embodiments, the food item replica 120 may further include an aroma creation device 230 disposed within a first cavity 222 of the food item replica 120. (See FIG. 6) The food item replica 120 may further include air vents 224 disposed on a top surface of the food item replica 120, 220d which are in fluid communication with the first cavity 222. The aroma creation device 230 creates and/or emits an aroma identical to the food item it is intended to replicate which is then vented to the customer via the air vents 224. In exemplary embodiments, the aroma creation device 230 includes scents, sprays, candles, stickers, patches or various other aroma emitting means.

In alternative exemplary embodiments, the aroma creation device 230 may include a dispersing means 236, such as a fan, disposed within the cavity 222 to assist in dispersing the aroma to the customer through the air vents 224.

In an alternative exemplary embodiment, the food selection system 100 includes a food item replica housing 120 having at least one storage compartment or cavity 222 and a plurality of air vents 224 and an aroma creation device 230 to create an aroma stored within the at least one storage compartment 222. Also, an exterior surface of the food item replica housing 120 is formed to resembles a desired food item or combination food platter, and the plurality of air vents 224 connect the at least one storage compartment 222 to the exterior surface.

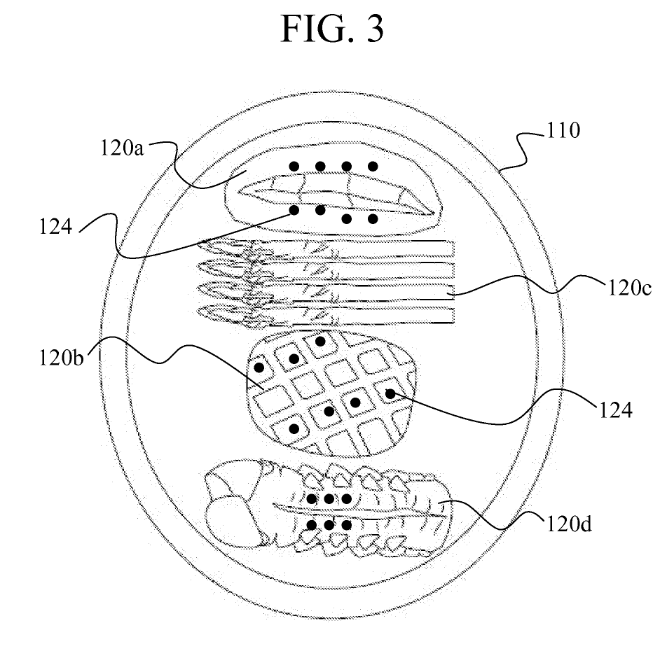

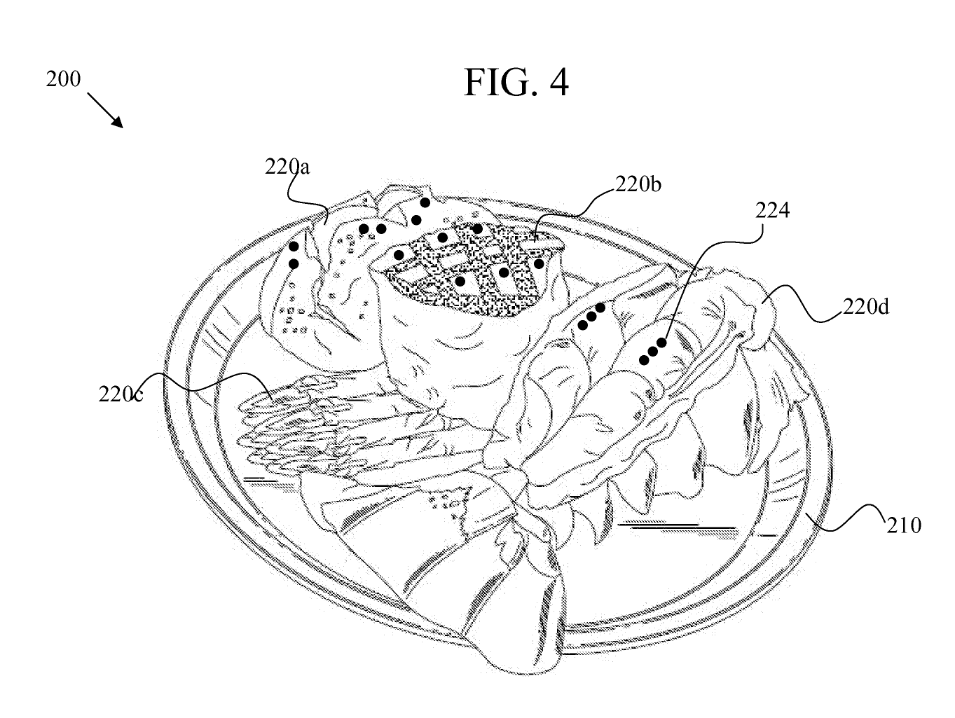

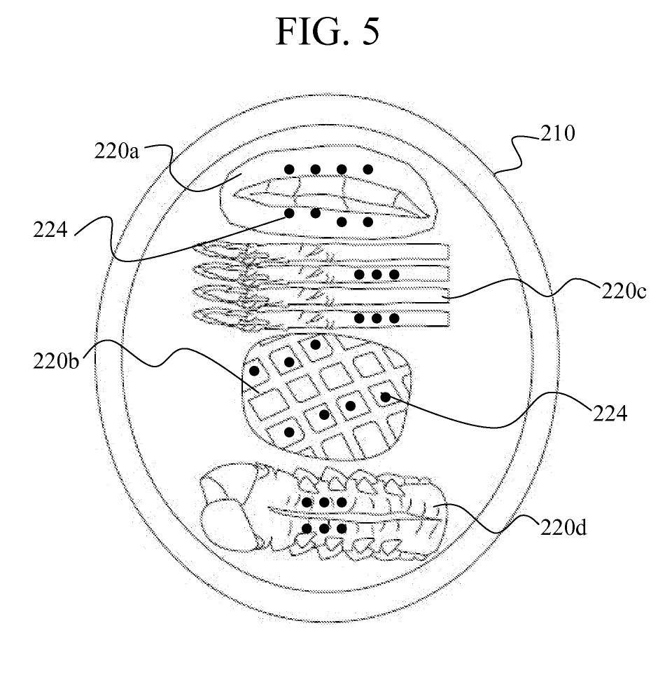

FIG. 3 is a top plan view of the food item replica 120 according to another exemplary embodiment. FIG. 4 is a top perspective schematic view of the food item replica 120 according to another exemplary embodiment and FIG. 5 is top plan view of the food item replica 120 illustrated in FIG. 4. FIG. 6 is a cross-sectional schematic view of the food item replica according to another exemplary embodiment.

Referring to FIGS. 3 and 6, in an alternative exemplary embodiment, the food item replica 120 may further include a second cavity 226 which is also in fluid communication with the air vents 224 to store a smoke and/or vapor creation device 240 or material. In an exemplary embodiment, the second cavity 226 may store a vapor creation device such as dry ice, so that when a user drops water or other liquid through the air vents 224 into the second cavity 226, vapor from the dry ice is emitted to thereby replicate steam from a freshly cooked food item through air vents 224.

As a result, all of the customer's senses will be stimulated in order to entice the customer to select and purchase a desired food item. For example, the user may create a food item replica 120 to be identical to a size, shape, color, ingredients, portion size, and look to a popular food item at his/her restaurant.

The user may then install an aroma insert 232, which smells the same as the food item, into the aroma creation device 230. The user may then activate a dispersing means 232 to increase the amount of aroma and/or vapor is passed through the air vents 224 to the customer.

In addition, the user may insert a piece of dry ice within the second cavity 226 of the food item replica 120 to replicate the look of smoke or steam emanating from the food item replica 120. That is, once the dry ice is placed within the second cavity 226 and the user drops a liquid onto the dry ice through the air vents 224, vapor from the dry ice would be emitted from the food item replica 120 through the air vents 224.

Referring to FIG. 2, in an alternative exemplary embodiment, the food selection system 100 includes a plate 110 having at least one food item replica 120, such as a baked potato 120a, a steak 120b, asparagus 120c, or a lobster 102d disposed thereon, and a garnish item (not illustrated). The steak 120b would include an aroma insert 132a corresponding to the smell of a steak. The lobster 120d would include an aroma insert 132 corresponding to the smell of a lobster, and similarly, the baked potato 120a would include an aroma insert 132 corresponding to the smell of a baked potato 120a.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A food selection system comprising:
a housing have at least one storage compartment and a plurality of air vents; and
an aroma creation device to create an aroma stored within the at least one storage compartment,
wherein an exterior surface of the housing resembles a food item, and the plurality of air vents connect the at least one storage compartment to the exterior surface.

2. The food selection system of claim 1, wherein the aroma created by the aroma creation device is emitted through the exterior surface through the plurality of air vents.

3. The food selection system of claim 1, further comprising a second storage compartment disposed within the housing, the second storage compartment configured to store a smoke creation device, wherein the second storage compartment is in fluid communication with the plurality of air vents.

4. The food selection system of claim 3, wherein the smoke creation device includes a dry ice smoke machine.

5. The food selection system of claim 4, wherein the smoke creation device emits simulated heat or steam.

6. A method for using a food selection system, the food selection system including a housing having a plurality of storage compartments and a plurality of air vents, the method comprising:
creating the housing to resemble a desired food item;
installing an aroma creation device to create an aroma corresponding to the food item disposed within a first storage compartment of the plurality of storage compartments;
displaying the housing and activating the aroma creation device,
wherein the created aroma corresponds to the desired food item.

7. The method of claim 6, the food selection system further comprising a smoke creation device to emit vapor or smoke, wherein the created aroma and emitted vapor or smoke simulate the desired food item.

8. The method of claim 6, wherein the housing further comprises a second storage compartment configured to store dry ice, the method further comprises dropping a liquid into the plurality of air vents to contact the stored dry ice to release vapor through the plurality of air vents.

9. The method of claim 6, wherein the housing further comprises a second storage compartment configured to store dry ice, the method further comprises dropping a liquid into the plurality of air vents to contact the stored dry ice to release vapor through the plurality of air vents.

10. The method of claim 6, wherein the stored dry ice vapor is released as simulated heat or steam.
